(19) United States
(12) Patent Application Publication
(10) Pub. No.: US 2016/0188022 A1
(43) Pub. Date: Jun. 30, 2016

(54) LENS LAYER OF NAKED EYE THREE-DIMENSIONAL DISPLAY DEVICE AND ELECTRODE STRUCTURE THEREOF

(71) Applicant: SHENZHEN CHINA STAR OPTOELECTRONICS TECHNOLOGY CO., LTD., Shenzhen (CN)

(72) Inventor: Chengliang Ye, Shenzhen (CN)

(73) Assignee: SHENZHEN CHINA STAR OPTOELECTRONICS TECHNOLOGY CO., LTD., Shenzhen (CN)

(21) Appl. No.: 14/418,776

(22) PCT Filed: Jan. 8, 2015
(86) PCT No.: PCT/CN2015/070316

§ 371 Date: Jan. 30, 2015

(30) Foreign Application Priority Data
Dec. 30, 2014 (CN) 201410853154.5

(51) Int. Cl. G06F 3/041; G02B 27/22; G02F 1/1333

(52) U.S. Cl. CPC G06F 3/041; G02F 1/13338; G02B 27/225

(57) ABSTRACT

A lens layer of a naked eye three-dimensional display device and an electrode structure are provided. The lens layer has an upper substrate, a lower substrate, a liquid crystal layer, a plurality of stripe-like electrodes, and a touch electrode. The stripe-like electrodes are formed on an upper substrate of the lens layer. The touch electrode is opposite the stripe-like electrodes and comprises a plurality of lump-like touch portions, wherein the lump-like touch portions are arranged on a lower substrate of the lens layer and connect to a touch-control circuit. An entire thickness of the lens layer can be reduced by disposing the lump-like touch portions.

### FIELD OF THE INVENTION

The present invention relates to a technical field of a lens layer of a naked eye three-dimensional display, and in particular to a lens layer of a naked eye three-dimensional display device and an electrode structure.

### BACKGROUND OF THE INVENTION

Currently, with the continuous development of LCD technology, three-dimensional display technology has been an area of interest, as the three-dimensional display technology can allow the images to show more realism. The basic principle is that the left eye and right eye receive different images, and the images are superimposed by the brain to form a three-dimensional image.

In order to achieve a three-dimensional display, a layer of the naked eye three-dimensional switching screen is added in front of an LCD display screen. The naked eye three-dimensional switching screen is switched by the switching principle of the three-dimensional display, such as a lenticular lens type or a barrier type. Both of these types can be switched by a switching liquid crystal screen. For example, a switching liquid crystal screen of the lenticular lens type consists of an upper substrate, a lower substrate, and a liquid crystal layer disposed between the upper substrate and the lower substrate. The upper substrate has plate electrodes, and the lower substrate has stripe-like electrodes.

When a potential and an electric field are generated between the plate electrodes and the stripe-like electrodes, the liquid crystal molecules corresponding to the stripe-like electrodes are rotated, and the rest of the liquid crystal molecules maintain an original shape and are not rotated. Thus, the light emitted from the LCD display screen through the switching liquid crystal screen converges, and a parallax is formed between the left eye and the right eye to achieve a three-dimensional display mode.

However, with the continuous development of touch-control screen technology, a touch-control and naked eye three-dimensional display device has appeared and has combined a touch-control screen and a three-dimensional display. The structure of the display device is that a touch-control substrate is disposed in front of the three-dimensional switching screen. But the process is complex, which increases the cost of production, and an entire thickness of the display device is increased by disposing the touch-control substrate.

### SUMMARY OF THE INVENTION

A primary object of the present invention is to provide a lens layer of a naked eye three-dimensional display device which reduces an entire thickness of the lens layer by disposing lump-like touch portions.

A second object of the present invention is to provide an electrode structure of a lens layer of a naked eye three-dimensional display device; a touch electrode is directly disposed in the lens layer, and the production of a touch layer can be avoided.

To achieve the above objects, the present invention provides an electrode structure disposed in a lens layer of a naked eye three-dimensional display device which comprises a plurality of stripe-like electrodes and a touch electrode. The stripe-like electrodes are formed on an upper substrate of the lens layer for generating an electric field. The touch electrode is opposite the stripe-like electrodes and comprises a plurality of lump-like touch portions, wherein the lump-like touch portions are arranged on a lower substrate of the lens layer and connect to a touch-control circuit, and a size of the lump-like touch portion corresponds with a size of a finger.

In one embodiment of the present invention, a projection of the stripe-like electrodes on the lower substrate does not overlap with the touch electrode, and a projection of the touch electrode on the upper substrate does not overlap with the stripe-like electrodes.

In one embodiment of the present invention, the lump-like touch portions are arranged on a top surface of the lower substrate to form a plurality of columns, and an interval of the lower substrate is formed between two adjacent columns, and corresponds to the related stripe-like electrode.

In one embodiment of the present invention, an extending direction of each of the stripe-like electrodes is parallel to an arrangement direction of each of the columns.

To achieve the above object, the present invention provides an electrode structure disposed in a lens layer of a naked eye three-dimensional display device which comprises a plurality of stripe-like electrodes and a touch electrode. The stripe-like electrodes are formed on an upper substrate of the lens layer for generating an electric field. The touch electrode is opposite the stripe-like electrodes and comprises a plurality of lump-like touch portions, wherein the lump-like touch portions are arranged on a lower substrate of the lens layer and connect to a touch-control circuit.

In one embodiment of the present invention, a projection of the stripe-like electrodes on the lower substrate does not overlap with the touch electrode, and a projection of the touch electrode on the upper substrate does not overlap with the stripe-like electrodes.

In one embodiment of the present invention, the lump-like touch portions are arranged on a top surface of the lower substrate to form a plurality of columns, and an interval of the lower substrate is formed between two adjacent columns, and corresponds to the related stripe-like electrode.

In one embodiment of the present invention, an extending direction of each of the stripe-like electrodes is parallel to an arrangement direction of each of the columns.

In one embodiment of the present invention, the touch electrode comprises a plurality of common pole wires connected to the lump-like touch portions respectively, and each of the common pole wires is formed in the related interval of the lower substrate.

In one embodiment of the present invention, an interval of the upper substrate is formed between two adjacent stripe-like electrodes, and corresponds to the related column of the lump-like touch portions.

In one embodiment of the present invention, each of the stripe-like electrodes comprises an electrode wire, and each electrode wires are formed on two opposite sides of the upper substrate.

In one embodiment of the present invention, the common pole wires and the electrode wires are wired on a side of the lower substrate.

In one embodiment of the present invention, the stripe-like electrodes and the touch electrode are transparent conductive films.

To achieve the above objects, the present invention provides a lens layer of a naked eye three-dimensional display device which comprises an upper substrate, a lower substrate, a liquid crystal layer, a plurality of stripe-like electrodes, and a touch electrode. The lower substrate is disposed below the upper substrate. The liquid crystal layer is filled between the upper substrate and the lower substrate. The stripe-like electrodes are formed on an upper substrate of the lens layer for generating an electric field. The touch electrode is opposite the stripe-like electrodes and comprises a plurality of lump-like touch portions, wherein the lump-like touch portions are arranged on a lower substrate of the lens layer and connect to a touch-control circuit.

In one embodiment of the present invention, a size of the lump-like touch portion corresponds with a size of a finger.

As stated above, the lens layer can be used for touch-control by disposing the lump-like touch portions. Thus, the production of a touch layer can be avoided, and an entire thickness of the lens layer can be reduced.

### DESCRIPTION OF THE DRAWINGS

FIG. 1 is a cross-sectional view of a naked eye three-dimensional display device according to an embodiment of the present invention.

FIG. 2 is an exploded view of a lens layer of a naked eye three-dimensional display device according to an embodiment of the present invention.

FIG. 3 is a top view of a touch electrode of a lens layer of a naked eye three-dimensional display device according to an embodiment of the present invention.

FIG. 4 is an under view of stripe-like electrodes of a lens layer of a naked eye three-dimensional display device according to an embodiment of the present invention.

FIGS. 5 to 7 are schematic views of a touch-control circuit of a lens layer of a naked eye three-dimensional display device according to an embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto.

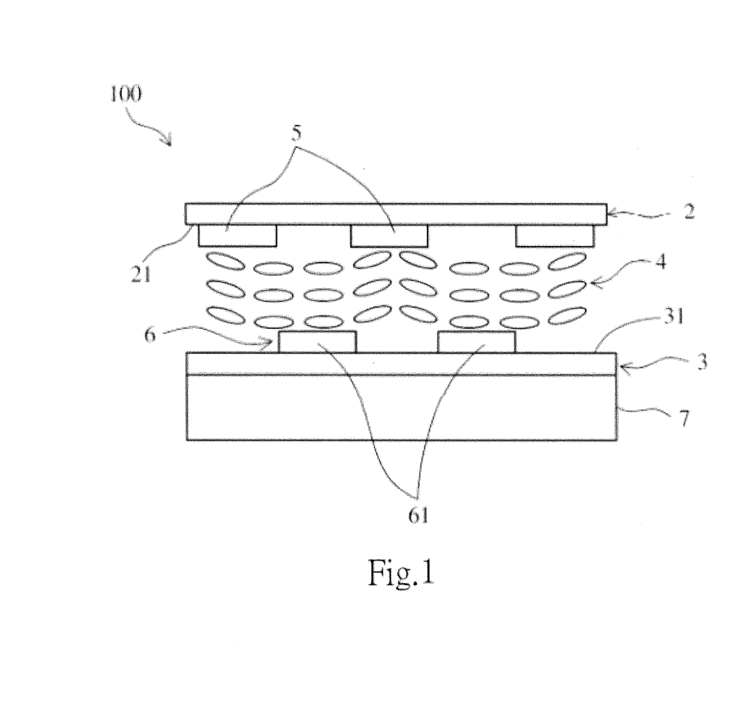

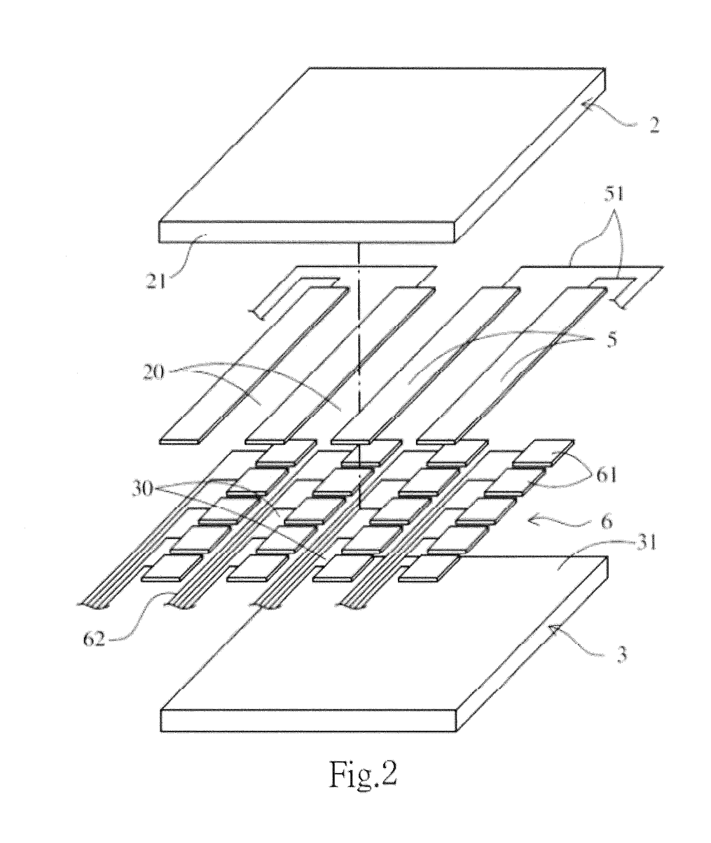

Refer to FIGS. 1 and 2. A three-dimensional display device 100 is a liquid crystal lens type according to an embodiment of the present invention and comprises an upper substrate 2, a lower substrate 3, a liquid crystal layer 4, a plurality of stripe-like electrodes 5, a touch electrode 6, and an LCD module 7, wherein the upper substrate 2, the lower substrate 3, the liquid crystal layer 4, the stripe-like electrodes 5, the touch electrode 6, and the LCD module 7 assemble to a lens layer (switching liquid crystal cell) having the functions of naked eye 3D and touch-control. The lens layer is disposed in front of the LCD module 7 (shown in FIG. 1), and the LCD module 7 has a backlight module and a liquid crystal display module. A backlight is generated from the backlight module through the liquid crystal display module to generate a 2D image. The 2D image is emitted to generate a 3D image. The detailed structure of each component, assembly relationships, and principle of operation in the present invention will be described in detail hereinafter.

Refer to FIGS. 1 and 2. The lower substrate 3 is disposed below the upper substrate 2, and the liquid crystal layer 4 is filled between the upper substrate 2 and the lower substrate 3.

Refer to FIGS. 1 and 2, the stripe-like electrodes 5 are formed on the upper substrate 2 for generating an electric field. The touch electrode 6 is formed on the lower substrate 3, and the touch electrode 6 is opposite the stripe-like electrodes 5. A projection of the stripe-like electrodes 5 on the lower substrate 3 does not overlap with the touch electrode 6, and a projection of the touch electrode 6 on the upper substrate 2 does not overlap with the stripe-like electrodes 5.

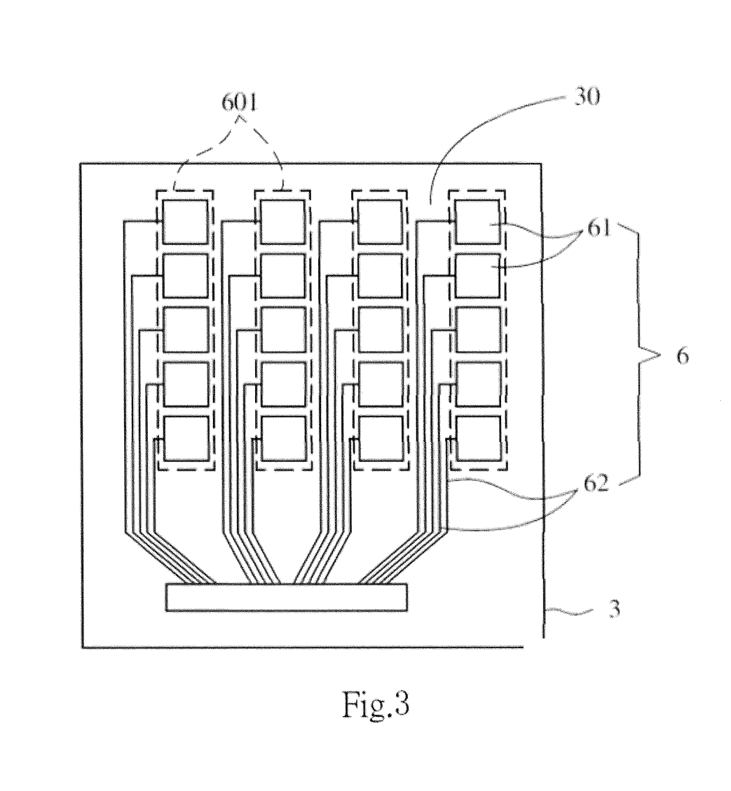

Refer to FIGS. 2 and 3. The touch electrode 6 comprises a plurality of lump-like touch portions 61 and a plurality of common pole wires 62. The size of lump-like touch portions 61 is the same, and the lump-like touch portions 61 are rectangular. In the embodiment, a size of the lump-like touch portion corresponds with a size of a finger, and the range is approximately 3 mm² to 4 mm². The lump-like touch portions 61 connect to a touch-control circuit, and the lump-like touch portions 61 are arranged on a top surface 31 of the lower substrate 3 to form a plurality of columns 601 (shown in FIG. 3). An interval 30 of the lower substrate is formed between two adjacent columns 601, and corresponds to the related stripe-like electrode 5. In the embodiment, an extending direction of each of the stripe-like electrodes 5 is parallel to an arrangement direction of each of the columns 601. The common pole wires 62 are connected to the lump-like touch portions respectively, and each of the common pole wires 62 is formed in the related interval 30 of the lower substrate. A width of the common pole wire 62 is 4 mm to reduce a blind area.

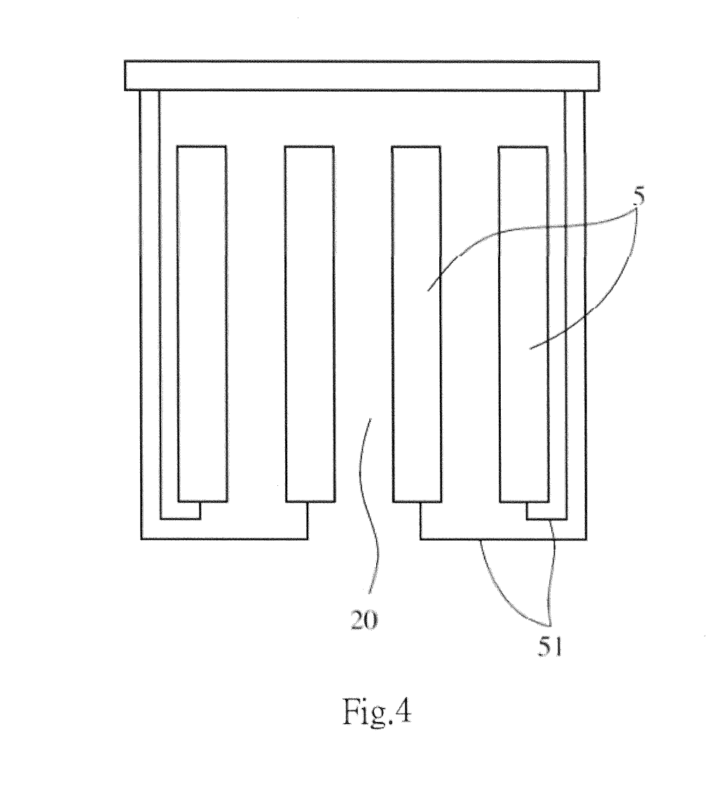

Refer to FIGS. 2 and 4. An interval 20 of the upper substrate is formed between two adjacent stripe-like electrodes 5, and corresponds to the related column 601 of the lump-like touch portions 61. Each of the stripe-like electrodes 5 comprises an electrode wire 51, and the electrode wires 51 are formed on two opposite sides of a bottom surface 21 of the upper substrate 2. The electrode wires 51 are electrically connected to the wires the lower substrate 3 by gold bumps, and the common pole wires 62 are bonded on a side of the lower substrate 3. In the embodiment, the stripe-like electrodes 5 and the touch electrode 6 are transparent conductive films.

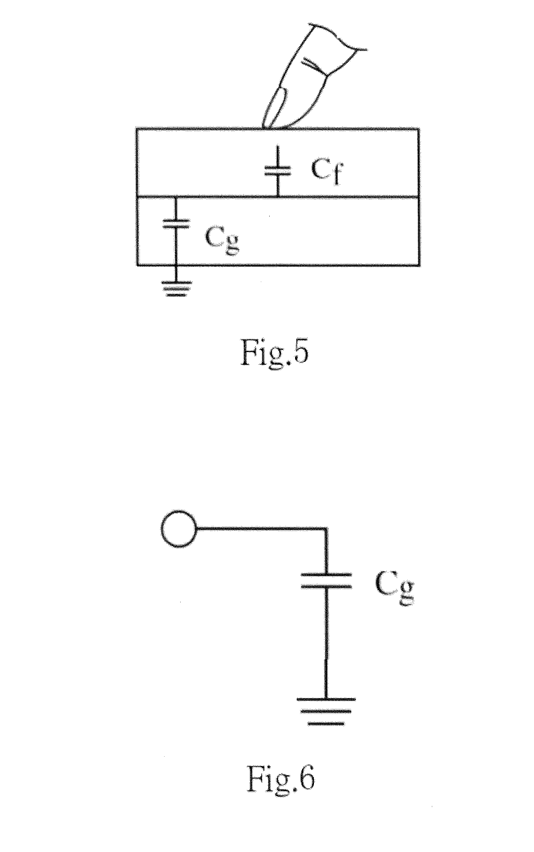

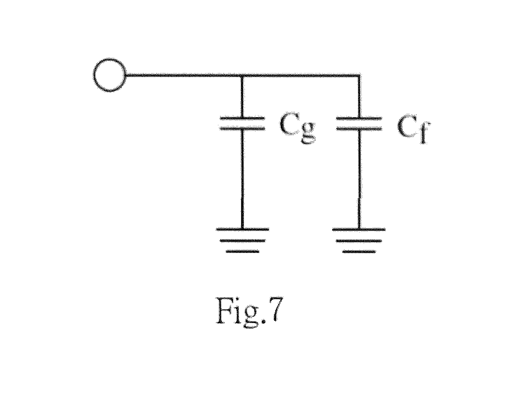

An equivalent capacitance view of the stripe-like electrodes 5 and the touch electrode 6 on the lower substrate 3 is shown in FIG. 5. Capacitance C_{f} is not grounded when untouched, and capacitance C_{g} is formed in FIG. 6. Capacitance C_{f} is grounded when touched, and capacitance C_{f} and capacitance C_{g} are connected in parallel. Therefore, the upper substrate 2, the lower substrate 3, the liquid crystal layer 4, the stripe-like electrodes 5, the touch electrode 6, and the LCD module 7 assemble to form a lens layer. A backlight is generated from the backlight module of the LCD module 7 through the liquid crystal display module of the LCD module 7 to generate a 2D image. The 2D image is emitted to generate a 3D image.

As stated above, the lens layer can be used for touch-control by disposing the lump-like touch portions 61. Thus the production of a touch layer can be avoided, and an entire thickness of the lens layer can be reduced to improve the transmittance.

The present invention has been described with preferred embodiments thereof, and it is understood that many changes and modifications to the described embodiments can be carried out without departing from the scope and the spirit of the invention that is intended to be limited only by the appended claims.

What is claimed is:

1. An electrode structure disposed in a lens layer of a naked eye three-dimensional display device comprising:
a plurality of stripe-like electrodes formed on an upper substrate of the lens layer for generating an electric field by applying a voltage; and
a touch electrode disposed opposite the stripe-like electrodes and comprising a plurality of lump-like touch portions, wherein the lump-like touch portions are arranged on a lower substrate of the lens layer and connected to a touch-control circuit, and a size of the lump-like touch portion corresponds with a size of a finger.

2. The electrode structure according to claim 1, wherein a projection of the stripe-like electrodes on the lower substrate does not overlap with the touch electrode, and a projection of the touch electrode on the upper substrate is not overlapped with the stripe-like electrodes.

3. The electrode structure according to claim 2, wherein the lump-like touch portions are arranged on a top surface of the lower substrate to form a plurality of columns, and an interval of the lower substrate is formed between two adjacent columns, and corresponds to the related stripe-like electrode.

4. The electrode structure according to claim 3, wherein an extending direction of each of the stripe-like electrodes is parallel to an arrangement direction of each of the columns.

5. An electrode structure disposed in a lens layer of a naked eye three-dimensional display device comprising:
a plurality of stripe-like electrodes formed on an upper substrate of the lens layer for generating an electric field; and
a touch electrode disposed opposite the stripe-like electrodes and comprising a plurality of lump-like touch portions, wherein the lump-like touch portions are arranged on a lower substrate of the lens layer and connect to a touch-control circuit.

6. The electrode structure according to claim 5, wherein a projection of the stripe-like electrodes on the lower substrate does not overlap with the touch electrode, and a projection of the touch electrode on the upper substrate does not overlap with the stripe-like electrodes.

7. The electrode structure according to claim 6, wherein the lump-like touch portions are arranged on a top surface of the lower substrate to form a plurality of columns, and an interval of the lower substrate is formed between two adjacent columns, and corresponds to the related stripe-like electrode.

8. The electrode structure according to claim 7, wherein an extending direction of each of the stripe-like electrodes is parallel to an arrangement direction of each of the columns.

9. The electrode structure according to claim 7, wherein the touch electrode comprises a plurality of common pole wires connected to the lump-like touch portions respectively, and the common pole wire is formed in the related interval of the lower substrate.

10. The electrode structure according to claim 9, wherein an interval of the upper substrate is formed between two adjacent stripe-like electrodes, and corresponds to the related column of the lump-like touch portions.

11. The electrode structure according to claim 10, wherein each of the stripe-like electrodes comprises an electrode wire, and each electrode wire are formed on two opposite sides of the upper substrate.

12. The electrode structure according to claim 11, wherein the common pole wires and the electrode wires are wired on a side of the lower substrate.

13. The electrode structure according to claim 5, wherein the stripe-like electrodes and the touch electrode are transparent conductive films.

14. A lens layer of a naked eye three-dimensional display device comprising:
an upper substrate;
a lower substrate disposed below the upper substrate;
a liquid crystal layer filled between the upper substrate and the lower substrate;
a plurality of stripe-like electrodes formed on an upper substrate of the lens layer for generating an electric field; and
a touch electrode disposed opposite to the stripe-like electrodes and comprising a plurality of lump-like touch portions, wherein the lump-like touch portions are arranged on a lower substrate of the lens layer and connect to a touch-control circuit.

15. The lens layer of a naked eye three-dimensional display device according to claim 14, wherein a size of the lump-like touch portion corresponds with a size of a finger.
